(19) United States
(12) Patent Application Publication
(10) Pub. No.: US 2005/0169244 A1
(43) Pub. Date: Aug. 4, 2005

(54) Control of packet network-based service servers using in particular dtmf signals

(76) Inventor: Joachim Luken, Munchen (DE)

Correspondence Address: Siemens Corporation;Intellectual Property Department, 170 Wood Avenue South, Iselin, NJ, 08830, US

(21) Appl. No.: 10/506,123

(22) PCT Filed: Aug. 30, 2002
(86) PCT No.: PCT/EP02/09695

(30) Foreign Application Priority Data
Mar. 12, 2002 (EP) 02005668.5

(51) Int. Cl. H04L 12/66

(52) U.S. Cl. 370/352; 370/522

(57) ABSTRACT

The invention relates to a method for controlling a network service and to transmission points, service servers, media servers and computer program products for carrying out said method. During the course of the convergence of line-oriented telephone networks and packet-oriented data networks to uniform networks, the aim of the invention is to also implement IN (intelligent network) services in data networks. IN services known per se are for example: VPNs (virtual private networks), calls with the aid of credit cards, or freephone connections via telephone numbers beginning with “0800”. The aim is to provide new IN services during the course of the integration of said services into the packet networks. To achieve this, during a connection from a first line network to a second line network via a packet network, incoming signals from the first line network are diverted from the information flow with the aid of a media gateway and are routed to an application server for intelligent network services via a signalling network. This enables an application server that is implemented in a packet network to also be controlled from a line network. This measure allows the control signals that are required to control the service server to reach the application server during a connection between a first subscriber and a second subscriber. If one of the subscribers transmits a control signal, which indicates a request for a network service that is managed by the service server, said control signal always reaches the service server, which can then provide the requested service. The inventive method is particularly suitable for supporting mid-call triggers.

### CROSS REFERENCE TO RELATED APPLICATIONS

This application is the US National Stage of International Application No. PCT/EP02/09695, filed Aug. 30, 2002 and claims the benefit thereof. The International Application claims the benefits of European application No. 02005668.5 filed Mar. 12, 2002, both of the applications are incorporated by reference herein in their entirety.

### FIELD OF INVENTION

The invention relates to a method for controlling a network service implemented in a packet network with the aid of a service server. The invention also relates to devices for executing the method.

### BACKGROUND OF INVENTION

The communication of information is effected at the present time by means of two types of communications networks: the conventional, line oriented telephone network which is used primarily for transmitting voice communications and the packet oriented data network which is designed principally for data communication. For conciseness, the line oriented telephone network is referred to in the following as a circuit switched network and the packet oriented data network as a packet switched network.

In the conventional circuit switched networks, not only is there a simple exchange of information between the connected subscribers but information relating to the control of the actual circuit switched network is also communicated. This information is evaluated not only by the terminal devices involved but also by the facilities associated with the network nodes. This exchange of information is referred to as signaling. Since, as a general rule, defined communication paths are reserved for signaling in circuit switched networks, one also speaks of signaling networks. As a general principle, the signaling can also take place by way of a packet switched network.

There is currently a tendency also to use packet switched networks for the communication of information which has hitherto been handled by way of conventional circuit switched networks. In the course of convergence of packet switched networks and circuit switched networks, voice calls are conducted by way of a packet switched network for example. The communication of telephone of voice calls by way of a packet switched network is also referred to as VoIP (Voice over IP). However broadband multimedia services, such as the transmission of videos for example, can also be implemented by way of a packet switched network. The transmission of the information previously transferred by circuit switched facilities under normal circumstances takes place with the aid of so-called real-time packet streams in the packet switched network, which are capable of transporting the information across the packet switched network in real time.

During the course of the convergence of line-oriented telephone networks and packet-oriented data networks to produce heterogeneous networks, the aim of the invention is also to implement so-called IN (Intelligent Network) services in the data networks. IN services known per se are for example: VPNs (Virtual Private Networks), calls made with the aid of credit cards or so-called “freephone” calls made using the telephone numbers beginning with “800”. It is anticipated that it will be possible to make new IN services available during the course of the integration of these services into the packet switched networks.

In the conventional circuit switched networks, the IN services are controlled by SCPs (Service Control Points) which are connected to the signaling network. In order to play back recorded announcements or to receive signal tones, so-called IPs (Intelligent Peripherals) are used, which are generally connected both to the signaling network and also to the switched of the conventional circuit switched network. The aforementioned signal tones are, for example, so-called DTMF (Dual Tone Multi Frequency) digits. In this context these DTMF digits are referred to as DTMF signal tones or signal tones for short.

In conventional telephone networks, the SCP is referenced by the switches whenever these switches detect certain triggers. These triggers can, for example, be certain telephone numbers or events such as busy connections, for example. The SCPs respond to the requests from the switches by activating an IP for example to play back an announcement. However the IP can also be used for the collection of signal tones.

If, for example, someone wishes to make a telephone call with the aid of a credit card, they will first dial a particular number, whereby the SCP referenced by the switches activates the IP, which plays back an announcement to the subscriber, in which the subscriber is requested to enter their credit card number and a PIN number. If the credit card number and PIN number communicated with the aid of the signal tones are valid, the subscriber is requested by a further announcement to enter the telephone number of the party they wish to call, whereupon the connection to the desired subscriber is established.

The situation occurs whereby the user wishes to conduct a further call with another subscriber after the end of the first telephone call without having to enter the credit card number and the PIN number again. For this situation, it is possible to make provision whereby the subscriber is again given the opportunity by pressing a function key on their terminal device, which is linked to a special signal tone, to make a call to a second party.

### SUMMARY OF INVENTION

IN services of this type are also to be made available in heterogeneous networks, i.e. the common packet switched and circuit switched networks. Provision is made for shifting the function of the SCPs in heterogeneous networks onto application servers, which are integrated into the packet switched network. These application servers are intended to control the IP services in a manner corresponding to the SCPs in the conventional telephone networks. The application servers are therefore also referred to as service servers in the following. Like SCPs in conventional telephone networks, the service servers must also be capable of being controlled by the subscribers. Hitherto however there has been a lack of any concept for controlling the service servers assigned to the data network.

Object of the invention is to specify methods and devices for controlling the service server assigned to a packet switched network.

This object is achieved firstly by means of a method comprising the following procedural steps:
establishment of a communication path from a first subscriber to a second subscriber by way of the packet switched network;
tapping the control signals required for controlling the service server off from the information flow between the first subscriber and the second subscriber and forwarding the control signals by way of a signaling network to the service server;
evaluation of the control signals by the service server; and
provision of a requested service feature by the service server.

With regard to a first method according to the invention, the control signals required for controlling the application server are tapped off from the information flow between the first subscriber and the second subscriber and forwarded to the service server by way of a signaling network. In this situation forwarding should not necessarily be understood to be an unchanged forwarding of the control signals but also the conversion of the control signals from a first signal form within the framework of a first communication protocol into a second signal form within the framework of a second communication protocol.

As a result of this measure, the control signals required for controlling the service server also reach the application server during a connection between the first subscriber and the second subscriber. Therefore, if one of the subscribers issues a control signal which indicates the request of a network service managed by the service server, this control signal will in any case reach the service server, which can thereupon provide the requested service. The method according to the invention is therefore particularly suitable for the interception of so-called mid-call triggers.

With regard to a preferred embodiment, the control signals are transmitted to the second subscriber at the same time.

This is advantageous if the second subscriber is likewise expecting the transmission of control signals, signal tones in particular. This is the case for example when the second subscriber in question is the call center of a direct bank.

With regard to a further preferred embodiment of the method, the control signals are signal tones which are tapped off from the information flow between the first subscriber and the second subscriber by a communication center between the packet switched network and the circuit switched network.

This method offers the advantage that communication centers can be used for this purpose which already handle the transmission of signal tones by way of the signaling network away from the actual communication path between the first subscriber and the second subscriber.

The above object is furthermore also achieved by means of a method comprising the following procedural steps:
establishment of a communication path from a subscriber to a media server;
communication of control information from the subscriber by way of the packet switched network to the media server;
evaluation of the control information by the media server and conversion of the control information into control signals for the service server;
forwarding the control signals by way of a signaling network to the service server;
evaluation of the control signals by the service server; and
provision of a requested service feature by the service server.

With regard to the method according to the invention, the transmission of control information to the media server can take place with the aid of the real-time packet stream which is also used for transmitting information between a first subscriber and a second subscriber in respect of any connection by way of the packet switched network. No further modifications are therefore needed with regard to the devices used. Rather, the evaluation of the control information is carried out by the media server which converts the control information into control signals for the service server and forwards the control information to the service server.

With regard to a special embodiment of this method, after the control information has been collected by the media server a communication path is established between a first subscriber and a second subscriber, whereby the control information occurring up to the time the communication path is cleared down is tapped off and fed to the service server.

By means of this preferred embodiment of the method, information can firstly be collected from subscribers by way of the media server and then a connection can be established between subscribers which also reacts to triggers occurring during the connection.

### BRIEF DESCRIPTION OF THE DRAWINGS

The invention will be described in detail in the following with reference to the attached drawings. In the drawings:

FIG. 1 shows a representation of the structure of a connection with a media server;

FIG. 2 shows a representation of the structure of a connection between a first subscriber and a second subscriber by way of a packet switched network; and

FIG. 3 shows a flowchart with reference to the connections represented in FIGS. 1 and 2.

### DETAILED DESCRIPTION OF INVENTION

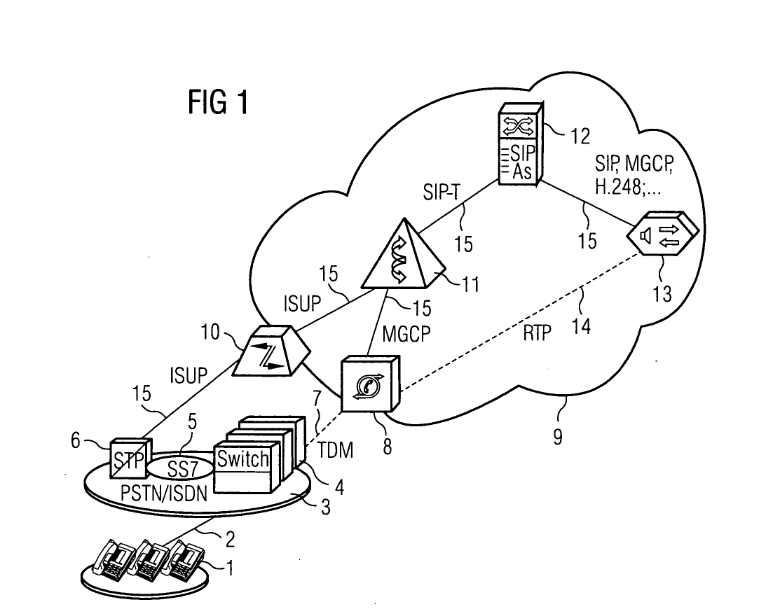

FIG. 1 shows the structure of a connection which is used to initialize an IN network service. In this situation, terminal devices 1 are connected by way of a local connection 2 to a conventional circuit switched network 3. The circuit switched network 3 comprises switches 4 which communicate with one another. The switches 4 additionally communicate by way of a signaling network 5, the usual SS7 network for example, with a signaling transfer point 6 which is referred to as STP 6 for short in the following. Furthermore, the switches 4 exchange information with a media gateway 8 by way of a TDM (time-division multiplexing) connection 7. The media gateway 8, which is referred to as MG 8 for short in the following, is the means by which the transition is effected from the circuit switched network 3 to a packet switched network 9.

The STP 6 communicates with the aid of ISUP (ISDN User Part) with a signaling gateway 10 which is referred to as SG 10 for short in the following. The signaling passes by way of the SG 10 from the circuit switched network 3 to the packet switched network 9.

A media gateway controller 11 is assigned to the signaling gateway 10 and the media gateway 8. The media gateway controller 11 is also referred to as MGC 11 for short in the following. The MGC 11 communicates with the signaling gateway 10 by means of ISUP and with the media gateway 8 by means of MGCP (Media Gateway Control Protocol). In addition, the MGC 11 communicates with the aid of SIP (Session Initiation Protocol) with an application server 12 which is connected by way of protocols such as SIP, MGCP or H.248 or similar protocols to a media server 13. The media server 13 in turn exchanges information with the media gateway 8 with the aid of an RTP (Real Time Transfer Protocol) data stream 14. A connection therefore exists by way of the switches 5 and the MG 8 between one of the terminal devices 1 and the media server 13. This connection is effected in the area of the circuit switched network 3 by way of local connections 8 and by way of a TDM connection 7. In the area of the packet switched network 9 it is not however possible to assign individual lines to the connection. Rather, the information in the area of the packet switched network 9 is transported by means of data packets which, depending on the packet switched network 9 in question, can take the form of Internet, X.25 or frame relay packets, or they may also take the form of ATM cells. The media server 13 is connected to the MG 8 by way of the data packets. In spite of the connectionless character in the true sense, a connection does therefore exist on the logically abstract level in the sense that, for example during the communication of information by means of TCP/IP with the aid of so-called flows, web server and browser are connected to one another.

The communication taking place between the STP 6, the SG 10, the MGC 11, the MG 8, the application server 12 and the media server 13 with the aid of the relevant protocols used for signaling purposes also represents a connection on the logically abstract level, which together form a signaling network 15, even if no particular lines are reserved for this.

In the packet switched network 9 the media server 13 assumes the functions which so-called IPs (Intelligent Peripherals) have exercised in conventional circuit switched networks 3, while the application server 12 assumes the functions of the SCPs (Service Control Points) 6 present in conventional circuit switched networks 3. The media server 13 can therefore play back announcements which are communicated to the subscriber at one of the terminal devices 1. In addition, the media server 13 is in a position to collect the signal tones issued by the terminal devices. The interrogation and collection of the signal tones is also known as UID (User Interactive Dialog). If compressing codecs such as G.723 are used in the MG 8, the transmission of the signal tones takes place in the RTP data stream 14 in special data packets according to RFC 2833 since the signal tones are otherwise corrupted during transmission. With regard to the use of non-compressing codecs, the signal tones can be transmitted together with the other voice information in a real-time packet stream.

The DTMF information communicated by the signal tones can be used for authenticating the subscriber at terminal device 1 or for interrogating the telephone number desired by the subscriber at terminal device 1.

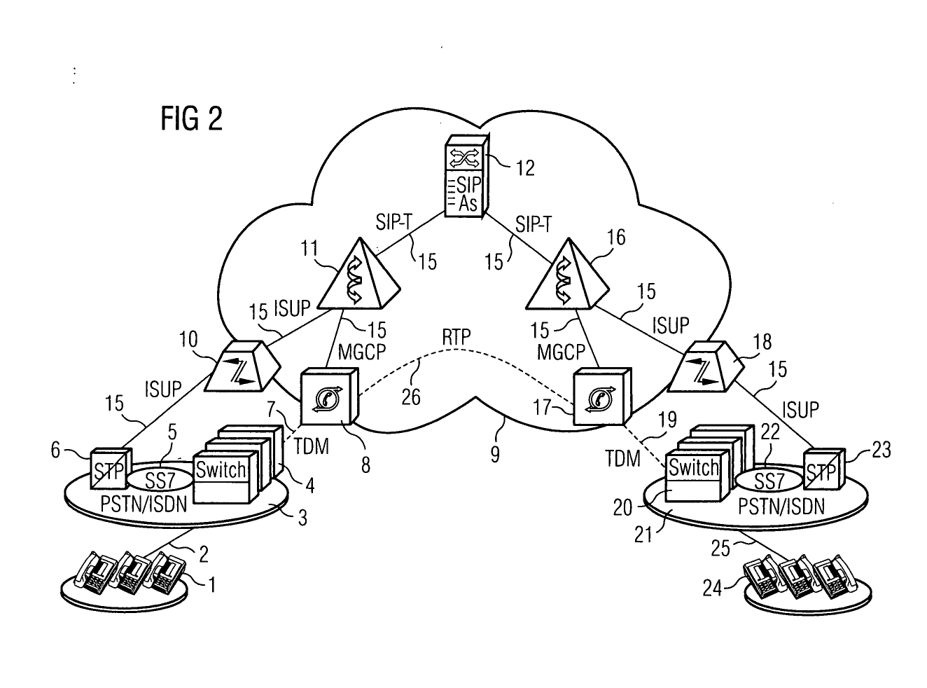

After the service information has been collected, the application server 12 initiates the clear-down of the connection to the media server 13 and attempts for example to establish a connection to the party the first subscriber wishes to call at terminal device 1. A connection of this type is represented in FIG. 2.

In order to establish a connection to a second subscriber, the application server 12 communicates not only with the MGC 11 on the so-called A side assigned to the first subscriber, but also with an MGC 16 on the B side. The media gateway controller 16 exchanges information by way of the signaling network 15 according to MGCP with the media gateway 17 and by way of ICUP with the signaling gateway 18. The media gateway 17 is connected by way of a TDM connection 19 to switches 20 which are assigned to a circuit switched network 21. In the circuit switched network 21, a signaling network 22 is also present which connects the switches 20 to a signaling transfer point 23. Finally, the switches 20 also establish a connection with one of the terminal devices 24 by way of a local connection 25.

The actual voice connection is effected between the MG 8 on the A side and the MG 17 on the B side with the aid of an RTP data stream 26. Signal tones which are coded in special packets according to RFC 2833 can also be transmitted in the RTP data stream 26 if compressing codecs are used in the MGs 8 and 17, or can be transmitted together with the other voice information if non-compressing codecs are used in the MGs 8 and 17.

When a connection is established between a first subscriber and a second subscriber, the media gateway 8 is switched over to a so-called out-of-band signaling. This means that the signal tones are no longer embedded in the RTP data stream 26 but are tapped off from the information flow between the first and the second subscriber with the aid of the SIP INFO method and forwarded to the application server 12 by way of the signaling network 15. The signaling according to the SIP INFO method is a signaling message which is sent to the application server 12 like other SIP messages. With the aid of this signaling message relating to the signal tones, a service logic circuit in the application server 12 can then be activated which, for example, clears down the connection to the second subscriber on the B side and connects the first subscriber to the media server 13 again.

Essentially, two special signaling procedures are required in order to allow implementation of the methods described here. On the one hand, during establishment of the connection to the media server 13 the MG 8 must signal its capability to the application server 12 of being able to transmit signal tones out-of-band. On the other hand, during establishment of the connection represented in FIG. 2 between the first subscriber and the second subscriber, the application server 12 must cause the MG 8 on the A side to switch over to the SIP INFO method.

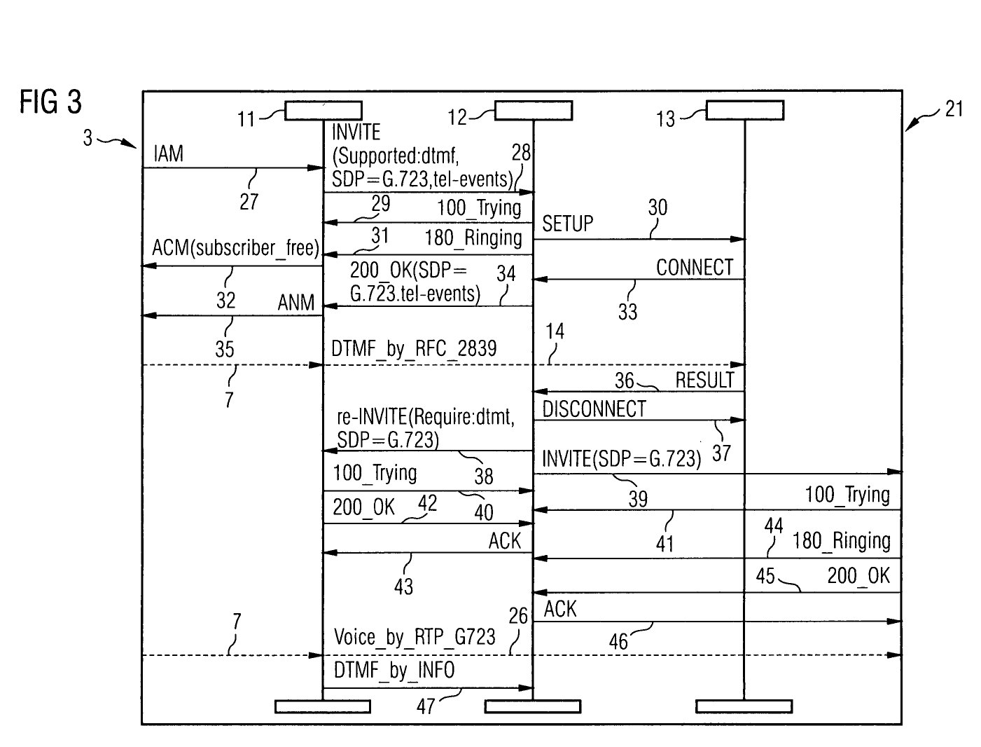

This is explained in more detail in the following with reference to the flowchart shown in FIG. 3. Firstly, an ISUP IAM (Initial Address Message) 27 is sent to the MGC 11 by a switch 4 in a circuit switched network 3. Thereupon, the MGC 11 signals in the SIP INVITE message 28 to the application server 12 that the MG 8 assigned to the MGC 11 supports the out-of-band transmission of signal tones. To this end, a new information element “dtmf” is inserted in the so-called “supported header”. Such an information element is also referred to as an “option tag”. In the present example, the SDP (Session Description Protocol) section in the SIP

INVITE message 28 also contains details relating to the codec used, namely G.723 and the entry “telephone events” which indicates that the transmission of the signal tones can take place by means of special data packets according to RFC 2833 in the RTP data stream 14.

The application server 12 then acknowledges receipt of the SIP INVITE message 28 to the MGC 11 in the SIP 100 Trying message 29 and attempts by means of a SETUP command 30 to cause the media server 13 to establish a connection to the MG 8 with the aid of the RTP data stream 14.

In the further course of the procedure, the application server 12 sends an SIP 180 Ringing message 31 to the MGC 11, which responds by issuing an ISUP ACM (Address Complete Message) message 32 to the circuit switched network 3. The SIP 180 Ringing message 31 and the ISUP ACM message 32 serve to cause the terminal device 1 to issue a bell signal. The two messages 31 and 32 are therefore optional.

The media server 13 reports the completion of connection establishment to the application server 12 with the aid of a CONNECT message 33. The application server 12 then sends an SIP 200 OK message 34 to the MGC 11, whose SDP section contains the codec to be used, namely G.723, and the entry “telephone events”. This entry indicates to the MGC 11 that the transmission of signal tones is to take place according to RFC 2833 in the RTP data stream 14. The SDP section in the SIP 200 OK message 34 then looks something like the following, for example:
v=0
o=alice 2890844526 2890844527 IN IP4 host.anywhere.com
s=New board design
e=alice@foo.org
t=0 0
c=IN IP4 host.anywhere.com
m=audio 49170 RTP/AVP 4 97
a=rtpmap:4 G723/8000
a=rtpmap:97 telephone-events

The MGC 11 then notifies the circuit switched network 3 of the successful connection establishment in the packet switched network 9 by means of an ISUP ANM message 35. Thus, with the aid of the of RTP data stream 14 set up between the MG 8 and the media server 13, information can be exchanged between the subscriber at one of the terminal devices 1 and the media server 13. The information flow between the circuit switched network 3 and the MG 8 is effected in this instance with the aid of the TDM connection 7.

After collection of the information communicated by the subscriber at one of the terminal devices 1 with the aid of voice or signal tones, the media server 13 notifies the result to the application server 12 in a RESULT message 36. The application server 12 responds to this with a DISCONNECT command 37 which serves to request the media server 13 to clear down the connection to the MG 8. Furthermore, the application server 12 sends an SIP re-INVITE message 38 to the MGC 11. This message 38 contains an information element “dtmf” in the so-called “require header”. This information element is also referred to as an “option tag”. Furthermore, the SIP re-INVITE message 38 no longer contains the entry “telephone events” which together with the specification of the G.723 codec used would instruct the MGC 11 to establish a connection with an RTP data stream. The SDP section within the message 38 then looks like the following:
v=0
o=alice 2890844526 2890844527 IN IP4 host.anywhere.com
s=New board design
e=alice@foo.org
t=0 0
c=IN IP4 host.anywhere.com
m=audio 49170 RTP/AVP 4
a=rtpmap:4 G723/8000

The MGC 11 is instructed by the SIP re-INVITE message 38 to transmit signal tones arriving out-of-band from the circuit switched network 3. The fact that the MG 8 assigned to the MGC 11 is in a position to do this has already been notified to the application server 12 by the MGC 11 in the SIP INVITE message 28.

In what follows, the MGC 16 on the B side receives a SIP INVITE message 39 which requests it to cause the assigned MG 17 to establish a connection with the MG 8 by way of the packet switched network 9. Receipt of the messages 38 and 39 is answered by the MGC 11 with the SIP 100 Trying message 40 and by the MGC 16 with the SIP 100 Trying message 41. After the connection has been set up, the MGC 11 issues the SIP 200 OK message 42 which is acknowledged by the application server 12 with the SIP ACK confirmation 43. The MGC 16 first sends the SIP 180 Ringing message 44 and then the SIP 200 OK message 45 which is acknowledged by the application server 12 with the SIP ACK confirmation 46. The connection between the first subscriber on the A side and the second subscriber on the B side is thus set up in the area of the packet switched network 9 with the aid of the RTP data stream 26. Digital signal tones in the information flow between the first subscriber and the second subscriber are however tapped off by the MGC 11 and forwarded with the aid of the SIP INFO method to the application server 12 by means of an out-of-band transmission 47, whereby the occurrence of signal tones is signaled to the application server.

If the application server 12 detects signal tones which again require switchover of the connection to the media server 13, the application server 12 again issues a message corresponding to the SIP 200 OK message 34 to the MGC 11 in order to cause this to establish a connection to the media server 13 by means of the RTP data stream 14.

As a result of the method described here, a connection is thus implemented by way of the packet switched network 9, in which the traffic streams in the TDM connections 7 and 19 are converted by the compressing codecs G.723 present in the MGs 8 and 17 into the RTP data stream 26. In this situation, the signal tones can be transmitted with special RTP packets according to RFC 2833. Transmission in special RTP packets is needed because the compressing codecs G.723 would otherwise corrupt the signal tones.

The special feature of the method described here consists in the fact that when the connection is set up a switchover takes place from the A side to the B side, from transmission of the signal tones according to RFC 2833 to an out-of-band transmission by way of the signaling network 15 with the aid of the SIP INFO method. In this way, so-called “mid-call triggers” can be recognized during the connection between the first subscriber and the second subscriber by way of the packet switched network 9.

The information element “dtmf” introduced by the example of FIG. 1 is needed inasmuch as otherwise non-compressing codecs, such as G.711 for example, cannot be switched over to out-of-band transmission. This is because non-compressing codecs according to G.711 transmit signal tones without distinction together with the remaining audible signals, with the result that an out-of-band transmission is not provided for in the conventional standards. It is therefore necessary to provide the information element “dtmf” which serves to indicate to the application server that the MG in question can handle the out-of-band transmission, and which allows the MG in question to be switched over to out-of-band transmission.

It should be stressed that the method described here does not necessarily have to be implemented in the quoted standards. An analogous implementation in corresponding standards is also possible.

It should also be stressed that concepts such as media gateway, media gateway controller, application server and media server are to be understood in the functional sense. These logical units need not necessarily constitute physical units, but can also be implemented in the form of software in a physical unit or may also be distributed over a number of physical units.

1-11. (canceled)

12. A method for controlling a network service, comprising:
providing a packet switched network;
providing a service server arranged in the packet switched network for implementing the network service;
providing a communication path via the packet switched network for transmitting an information flow between a first subscriber and a second subscriber;
providing control signals to control the network service, wherein the control signals are optionally tapped off from the information flow;
establishing the communication path;
activating the optional tapping off during establishment of the communication path;
forwarding the tapped off control signals via a signaling network to the service server; and
controlling the network service by the service server using the forwarded control signals.

13. The method according to claim 12, wherein the control signals are also forwarded to the second subscriber in parallel to being forwarded to the service server.

14. The method according to claim 12, wherein tapping off is deactivated during the de-establishment of the communication path.

15. The method according to claim 13, wherein tapping off is deactivated during the de-establishment of the communication path.

16. The method according to claim 12, wherein a potential tapping off point indicates whether it supports the optional tapping off of control signals.

17. The method according to claim 13, wherein a potential tapping off point indicates whether it supports the optional tapping off of control signals.

18. The method according to claim 14, wherein a potential tapping off point indicates whether it supports the optional tapping off of control signals.

19. The method according to claim 12, wherein
the first subscriber is assigned to a circuit switched network, and wherein
the control signals are tapped off by a communication center located between the packet switched network and the circuit switched network.

20. The method according to claim 19, wherein in the area of the circuit switched network the control signals are configured as signal tones.

21. The method according to claim 13, wherein
the first subscriber is assigned to a circuit switched network, and wherein
the control signals are tapped off by a communication center located between the packet switched network and the circuit switched network.

22. The method according to claim 14, wherein
the first subscriber is assigned to a circuit switched network, and wherein
the control signals are tapped off by a communication center located between the packet switched network and the circuit switched network.

23. The method according to claim 16, wherein
the first subscriber is assigned to a circuit switched network, and wherein
the control signals are tapped off by a communication center located between the packet switched network and the circuit switched network.

24. The method according to claim 12, further comprising:
evaluating the control signals by a media server assigned to the service server during the establishment of the communication path;
converting the control signals into control signals for the service server; and
transmitting the control signals for the service server via the signaling network to the service server.

25. The method according to claim 13, further comprising:
evaluating the control signals by a media server assigned to the service server during the establishment of the communication path;
converting the control signals into control signals for the service server; and
transmitting the control signals for the service server via the signaling network to the service server.

26. The method according to claim 12, wherein the method is performed by a computer program running on at least one processor unit.

27. A manufacture, comprising:
mechanisms adapted to perform a method for controlling a network service, the method comprising:
providing a packet switched network;
providing a service server arranged in the packet switched network for implementing the network service;
providing a communication path via the packet switched network for transmitting an information flow between a first subscriber and a second subscriber;
providing control signals to control the network service, wherein the control signals are optionally tapped off from the information flow;
establishing the communication path;
activating the optional tapping off during establishment of the communication path;
forwarding the tapped off control signals via a signaling network to the service server; and
controlling the network service by the service server using the forwarded control signals.

28. A manufacture according to claim 27, wherein the manufacture is a communication network.

29. A manufacture—particularly a communication center, service server or media server—comprising means, which are set up to execute those steps of a method according to one of the preceding method claims, which are effected by the product and are thereby set up in particular to execute interactions of the products as prescribed according to the method with at least one further product, the means of which are set up to execute the remaining steps of the method.
